(19) United States
(12) Patent Application Publication
(10) Pub. No.: US 2025/0153291 A1
(43) Pub. Date: May 15, 2025

(54) MUTIFUNCTIONAL TRIMMING MACHINE FIXTURE

(71) Applicant: Nurlan BABAYEV, Tianjin (CN)

(72) Inventor: Nurlan BABAYEV, Tianjin (CN)

(21) Appl. No.: 18/761,006

(22) Filed: Jul. 1, 2024

(30) Foreign Application Priority Data
Nov. 15, 2023 (CN) 202311523568.7

(51) Int. Cl. B23Q 3/02

(52) U.S. Cl. CPC B23Q 3/02; B23Q 2716/08

(57) ABSTRACT

The present invention discloses a multifunctional trimming machine fixture and relates to the field of electric tool auxiliary devices. The multifunctional trimming machine fixture comprises: a base plate on which the trimming machine is detachably connected, the base plate is provided with a first cut-opening corresponding to the position of the trimming machine, and the cutter head of the trimming machine can pass through the first cut-opening to perform cutting; a slide plate, the slide plate is slidably connected to the bottom of the base plate along a first direction and can be fastened to a preset position on the bottom of the base plate by means of fasteners; wherein the slide plate is provided with at least one second cut-opening corresponding to the first cut-opening along the first direction. The trimming machine fixture is reasonably and compactly structured, can be conveniently disassembled and assembled, is conveniently portable and simple to operate, it provides cutting stability, high cutting accuracy and safety during use, and is capable of enabling quick switch of cutting function in a variety of application scenarios with strong adaptability, such as grinding, chamfering and grooving the edges of wood, cutting tenon grooves on thinner wood, cutting the wood into preset shapes (curved, circular, etc), thereby improving work efficiency.

### RELATED APPLICATION

This application claims the benefit of, and priority to, Chinese Invention Patent Application No. 202311523568.7, filed on Nov. 15, 2023, which is incorporated herein by reference in its entirety for all purposes.

### TECHNICAL FIELD

The present invention relates to the field of multiple electric tool auxiliary devices and, more particularly, to a multifunctional trimming machine fixture.

### BACKGROUND

Trimming machine is a general electric power tool that has a flat base and a rotating blade that extends out of the base, and the spindle of which can be driven by an electric motor or a pneumatic motor. Common trimming machines are handheld or fixed to a custom-made table and have a wide range of application scenarios and may be used for cutting hard materials (such as wood or plastic). For example, in woodwork engineering, the edges of wood are sanded, trimmed and chamfered, or tenon grooves are cut on wood.

Most prior art trimming machines are fixed and large in size, and cutting is generally performed by moving the wood. It is difficult to ensure the accuracy and safety of cutting. There are also trimming machines that use fixtures movable within a certain range, i.e. the clamp is fixed at a certain position on the custom-made table, and cutting is performed on the selected area of the wood. These trimming machines have poor portability and relatively single function. It is difficult for them to perform multiple functions using a set of fixtures simultaneously, such as grinding, chamfering, and grooving the edges of the wood, cutting tongues and grooves on thinner wood, cutting the wood into preset shapes (curved, circular, etc) which often require a variety of auxiliary fixtures for them to be achieved. In addition, the woodworker needs to change the fixtures of the trimming machine many times, and performing cutting on the wood multiple times requires more time and effort, which reduces work efficiency.

### SUMMARY

In order to overcome the above technical problems, the present invention provides a trimming machine fixture that is reasonably and compactly structured, can be conveniently disassembled and assembled, safe to use, provides cutting stability and high cutting accuracy during use, and capable of enabling quick switch of cutting function in a variety of application scenarios. The present invention is implemented through the following technical solutions.

A multifunctional trimming machine fixture, comprising: a base plate on which the trimming machine is detachably connected, the base plate is provided with a first cut-opening corresponding to the position of the trimming machine, and the cutter head of the trimming machine can pass through the first cut-opening to perform cutting; a slide plate, the slide plate is slidably connected to the bottom of the base plate along a first direction and can be fastened to a preset position on the bottom of the base plate by means of fasteners; wherein the slide plate is provided with at least one second cut-opening corresponding to the first cut-opening along the first direction.

Preferably, the base plate comprises: a connecting plate configured to be connected to the trimming machine; an adjustment plate connected to one side of the connecting plate; wherein the adjustment plate is provided with an adjustment hole, the slide plate is provided with a number of fastening holes corresponding to the adjustment hole along the first direction, and the fasteners can be adapted to connect with the fastening holes along the adjustment hole and can be used to fasten the slide plate.

Preferably, the base plate further comprises: a guide plate, the guide plate being located at the bottom of the connecting plate and the adjustment plate, and configured to detachably connect the adjustment plate and the connecting plate; wherein a guide groove is formed between the guide plate and the connecting plate/the adjustment plate, and the slide plate can be limitedly connected to the guide groove and can linearly slide along the guide groove.

Preferably, it further comprises: a grip handle, the grip handle being connected to the base plate at one end thereof distal to the first cut-opening, wherein a storage space is provided in the grip handle. Preferably, a shielding member is detachably connected to the bottom of the slide plate corresponding to the position of the second cut-opening, and the shielding member is configured to prevent cutting debris from splashing outwards.

Preferably, the slide plate is provided with a first mounting hole adapted to one end of the shielding member, and one end of the shielding member is mounted in the first mounting hole and can rotate along the inside of the first mounting hole.

Preferably, the shielding member comprises a shielding portion, mounting portions and a snapping portion that are fixedly connected in sequence; the mounting portions are in the shape of an arc strip, and there are at least two, and the snapping portion is fixedly provided on the outer peripheral side of the mounting portion; the circumferential inner wall of the first mounting hole is provided with an arc-shaped groove for the snapping portion to be extruded and inserted. Preferably, a scale is marked on the slide plate along the first direction. Preferably, the base plate is provided with a cut-out hole for viewing the scale.

Preferably, the cut-out hole has a long strip structure, and an indicator piece that can move along the length direction of the cut-out hole is provided in the cut-out hole, the indicator piece is configured to indicate the scale, and the indicator piece is detachably connected to the base plate.

Preferably, the second cut-opening is opened at one end of the slide plate along the first direction, and when the slide plate slides relative to the base plate, the cutter head of the trimming machine can move linearly along the second cut-opening and/or move out of the edge of the slide plate along one end of the second cut-opening.

Preferably, it further comprises an edge guide plate, the edge guide plate being detachably connected to the bottom of the base plate or the bottom of the slide plate, the edge guide plate can be used to guide the cutter head of the trimming machine to cut along a preset trajectory or to adjust the height of the base plate and the slide plate.

Preferably, the edge guide plate is provided with an arc-shaped guide hole, and the guide hole can be used to guide the edge guide plate to be connected to the bottom of the base plate or the slide plate at a preset angle.

Preferably, it further comprises a center positioning member, and the slide plate is provided with at least one center positioning hole adapted to the center positioning member along the length direction, the slide plate can rotate with the central positioning member as the center of a circle.

Preferably, it further comprises a bushing connected to the bottom of the slide plate, the bushing being movable along the edge of the object to be cut and capable of guiding the cutter head of the trimming machine to cut along a preset trajectory.

Preferably, it further comprises a positioning pin detachably connected to the bottom of the guide plate or the slide plate, the positioning pin being configured to limit the object to be cut.

Preferably, it further comprises a horizontal knob, the horizontal knob being detachably connected to the bottom of the base plate or the bottom of the slide plate, and the horizontal knob can be used to adjust the height of the base plate and the slide plate.

Preferably, it further comprises a centering piece detachably connected to the connecting plate and a centering pin adapted to the centering piece, a centering hole coaxial with the first cut-opening is provided at the center of the centering piece, and the centering pin is adapted to the centering hole.

Compared to the prior art, the beneficial effects of the present invention are: the trimming machine fixture is reasonably and compactly structured, can be conveniently disassembled and assembled, is conveniently portable and simple to operate, provides cutting stability, high cutting accuracy and safety during use, and is capable of enabling quick switch of cutting function in a variety of application scenarios with strong adaptability, such as grinding, chamfering and grooving the edges of wood, cutting tenon grooves on thinner wood, cutting the wood into preset shapes (curved, circular, etc), thereby improving work efficiency.

### BRIEF DESCRIPTION OF THE DRAWINGS

Illustrative examples of the present disclosure are described in detail below with reference to the attached drawing figures, which are incorporated by reference herein, and wherein:

FIG. 1 is a structural schematic view of a trimming machine fixture in an embodiment of the present invention.

FIG. 2 is a structural schematic view of a base plate sliding relative to a slide plate in an embodiment of the present invention.

FIG. 3 is another structural schematic view of the base plate sliding relative to the slide plate in an embodiment of the present invention.

FIG. 4 is a structural schematic view from another perspective of the base plate sliding relative to the slide plate in an embodiment of the present invention.

FIG. 5 is a structural schematic view of a trimming machine fixture in another embodiment of the present invention.

FIG. 6 is an exploded view of FIG. 5.

FIG. 7 is a schematic view illustrating the installation of a shielding member in an embodiment of the present invention.

FIG. 8 is a schematic view illustrating the installation of an adjustment plate and indicator pieces in an embodiment of the present invention.

FIG. 9 is a structural schematic view of an edge guide plate in an embodiment of the present invention.

FIGS. 10a-10e are schematic views illustrating the installation steps for the trimming machine and the trimming machine fixture in an embodiment of the present invention.

FIGS. 11a-11b are schematic views of fasteners fastening the base plate and the slide plate in an embodiment of the present invention.

FIG. 12 is a schematic view illustrating the matching of positioning elements and central positioning holes in an embodiment of the present invention.

FIG. 13a is a schematic view illustrating a first cutting method in an embodiment of the present invention.

FIG. 13b is a schematic view illustrating a second cutting method in an embodiment of the present invention.

FIG. 13c is a schematic view illustrating a third cutting method in an embodiment of the present invention.

FIG. 13d is a schematic view illustrating a fourth cutting method in an embodiment of the present invention.

FIG. 13e is a schematic view illustrating a fifth cutting method in an embodiment of the present invention.

FIG. 14 is a schematic view illustrating the installation steps for the edge guide plate and the slide plate in an embodiment of the present invention.

FIG. 15 is a schematic view illustrating the edge guide plate and the slide plate in a usage state after their installation in an embodiment of the present invention.

FIG. 16 is a schematic view illustrating the edge guide plate and the slide plate in another usage state after their installation in an embodiment of the present invention.

FIG. 17 is a schematic view illustrating the edge guide plate and the slide plate in yet another usage state after their installation in an embodiment of the present invention.

FIG. 18 is a schematic view illustrating the installation of dowel pins and the base plate in an embodiment of the present invention.

FIG. 19 is a schematic view illustrating the dowel pins and the edge guide plate being in use in an embodiment of the present invention.

FIG. 20 is a schematic view illustrating the dowel pins and the edge guide plate being in use in another embodiment of the present invention.

FIG. 21 is a schematic view illustrating the installation of a shaft sleeve and the base plate in an embodiment of the present invention.

FIG. 22 is a schematic view illustrating the installation of a shaft sleeve and the base plate in another embodiment of the present invention.

FIG. 23 is a schematic view illustrating the installation and use of the shaft sleeve and the base plate in yet another embodiment of the present invention.

### DETAILED DESCRIPTION

For better understanding of the above purposes features, and advantages of the present application, it is described in further detail below with reference to the accompanying drawings and specific embodiments.

In the description of this application, it should be understood that the directional or positional relationships indicated by the terms “middle”, “top”, “bottom”, “inner”, “outer”, etc are based on the directional or positional relationships shown in the accompanying drawings, and are merely intended for the convenience of describing the present application and simplifying the description, rather than indicating or implying that the device or component referred to must have a specific direction, or be configured and operated in a specific direction, therefore the directional or positional relationships indicated by those terms cannot be construed as limitations on the present application. The terms “first” and “second” are only for descriptive purposes, and cannot be construed as indicating or implying relative importance, or implicitly indicating the quantity of the technical features referred to. Hence, a feature defined as “first” and “second” may explicitly or implicitly include one or more of that feature. In the description of the present invention, “a plurality of” means two or more, unless otherwise specifically defined.

In addition, unless otherwise explicitly specified and defined, the terms “installation”, “connected”, “connection”, “fastening”, etc should be understood in a broad sense. For example, it can be a fixed connection, a detachable connection, or an integrated connection; it can be a mechanical connection or an electrical connection; it can be a direct connection or an indirect connection through an intermediate medium, and it can be an internal connection between two components. For those of ordinary skill in the art, the specific meanings of the above terms in the present application can be understood based on specific circumstances.

In the present application, unless otherwise explicitly specified and defined, “above” or “below” a first feature or a second feature may include the first and second features having direct contact, and may also include the first and second features not in direct contact but being in contact through an additional feature between them. Furthermore, the first feature is “over”, “above” and “on top of” the second feature includes the first feature is directly above or obliquely above the second feature, or simply means that the first feature is higher in level than the second feature. The first feature is “under”, “beneath” and “at the bottom of” the second feature includes the first feature is directly below or obliquely below the second feature, or simply means that the first feature is slightly lower in level than the second feature.

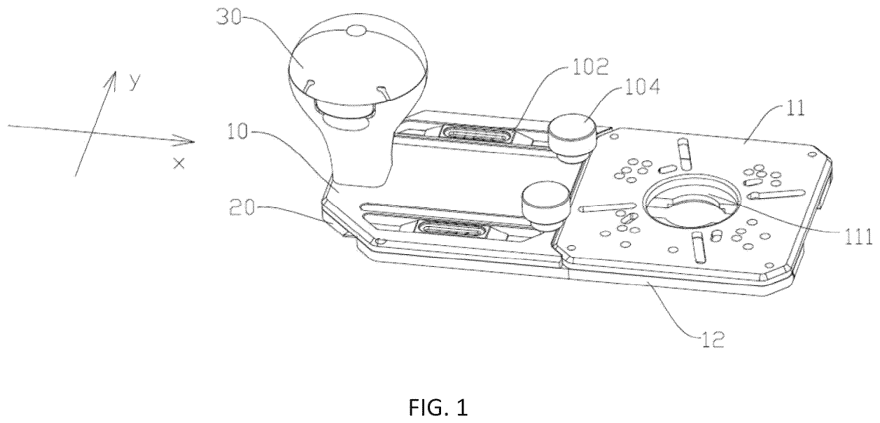

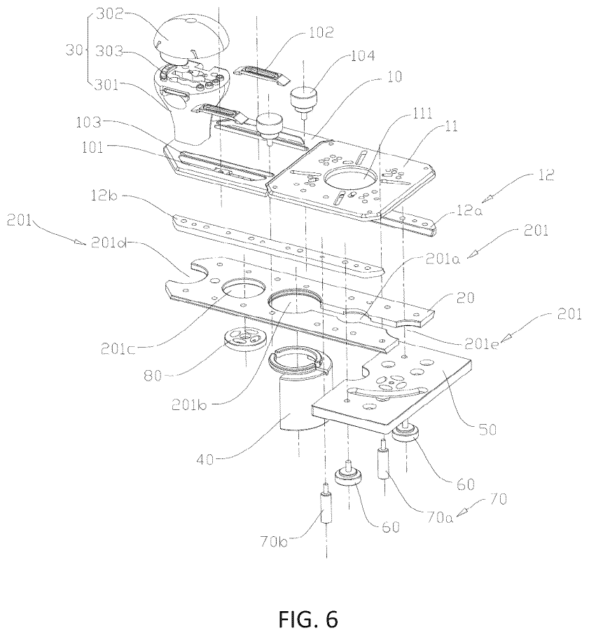

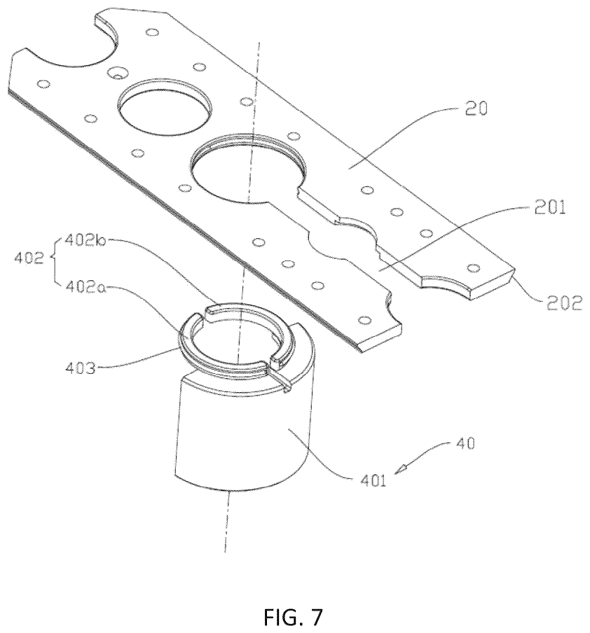

Referring to FIGS. 1-23, the present invention provides a multifunctional trimming machine mainly aimed at the problems associated with prior art trimming machines that are fixed and large in size, and cutting is generally performed by moving the wood. It is difficult to ensure the accuracy and safety of cutting. There are also trimming machines that use fixtures movable within a certain range, i.e. the clamp is fixed at a certain position on the custom-made table, and cutting is performed on the selected area of the wood. These trimming machines have poor portability and relatively single function. It is difficult for them to perform multiple functions using a set of fixtures simultaneously.

As shown in FIGS. 1-4, the multifunctional trimming machine comprises: a base plate on which the trimming machine 90 is detachably connected, the base plate is provided with a first cut-opening 111 corresponding to the position of the trimming machine 90, and the cutter head of the trimming machine 90 can pass through the first cut-opening 111 to perform cutting; a slide plate 20, the slide plate 20 is slidably connected to the bottom of the base plate along a first direction and can be fastened to a preset position on the bottom of the base plate by means of fasteners 104; wherein the slide plate 20 is provided with at least one second cut-opening 201 corresponding to the first cut-opening 111 along the first direction.

Referring to FIGS. 1-4, direction x in FIG. 1 is the first direction. In this embodiment, the base plate is extended along the first direction to define the position of the trimming machine 90, wherein the trimming machine 90 of the present application is mounted at one end of the base plate; and wherein for different cutting operations, i.e. when different cutting distances are required, the cutting distance can be determined by driving the slide plate 20 and the base plate to slide, followed by using the fasteners 104 to relatively fix the slide plate 20 and the base plate, which is simple and easy to operate.

Due to the presence of the first cut-opening 111 and the second cut-opening 201, the cutter head on the trimming machine 90 can smoothly contact the cutting surface of the object to be cut; it should be understood that the slide plate 20 can be designed to completely coincide with the base plate to reduce the size of the multifunctional trimming machine fixture for easier transportation.

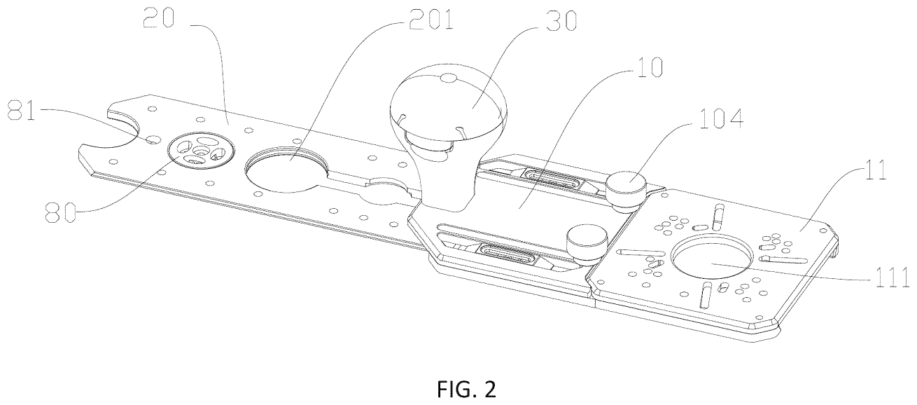

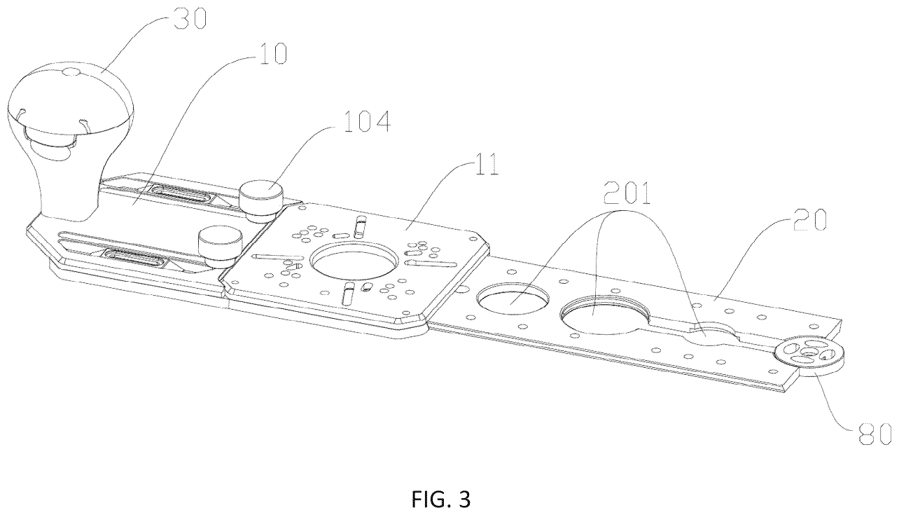

Specifically, due to different operating requirements and different cutting distances, in this embodiment, the slide plate 20 can be fastened to a preset position at the bottom of the base plate through the fasteners 104 to meet different cutting requirements. In actual operations, as shown in FIGS. 2 and 3, after adjusting the cutting distance, the slide plate 20 or one end of the base plate can be brought into contact with the reference object, and then the base plate and the trimming machine 90 are pushed to move after cutting, thereby achieving the desired cutting operation on the object to be cut. As shown in FIGS. 2 and 3, the slide plate 20 can slide out along the end of the bottom of the base plate distal to the trimming machine 90, and can also slide out along the end of the bottom of the base plate proximal to the trimming machine 90, depending on the actual operation needs.

Specifically, the second cut-opening 201 is opened at one end of the slide plate 20 along the first direction and the slide plate 20 slides relative to the base plate, the cutter head of the trimming machine 90 can move linearly along the second cut-opening 201 and/or move out of the edge of the slide plate 20 along one end of the second cut-opening 201.

In this embodiment, the number of the second cut-openings 201 is multiple to ensure that the cutter head of the trimming machine 90 can perform smooth cutting when the slide plate 20 and the base plate are kept at different positions. In a further embodiment, at least two second cut-openings 201 are connected to each other, and the cutter head can be prevented from being interfered by the slide plate 20 when the slide plate 20 moves relative to the base plate. In a further embodiment, at least two second cut-openings 201 are connected to each other and extended from the slide plate 20 to form an opening, and when the base plate slides relative to the slide plate 20, the cutter head of the trimming machine 90 can move linearly along the second cut-opening 201 and/or move out of the edge of the slide plate 20 along one end of the second cut-opening 201 and will not be interfered by the slide plate 20. This further improves the convenience of cutting operations.

Specifically, the base plate comprises: a connecting plate 11 configured to be connected to the trimming machine 90; an adjustment plate 10 connected to one side of the connecting plate 11; wherein the adjustment plate 10 is provided with a first adjustment hole 103, the slide plate 20 is provided with a number of fastening holes 203 corresponding to the first adjustment hole 103 along the first direction, and the fasteners 104 can be adapted to connect with the fastening holes 203 along the first adjustment hole 103 and can be used to fasten the slide plate 20.

In this embodiment, the first cut-opening is disposed on the connecting plate 11, wherein the connecting plate 11 is embedded at one end of the adjustment plate 10, so that the upper surfaces of the connecting plate 11 and the adjustment plate 10 substantially flush, and the connecting plate 11 and the trimming machine 90 are first fixedly mounted, and the connecting plate 11 is then embedded at a position corresponding to the adjustment plate 10 to realize the limit between the connecting plate 11 and the adjustment plate 10, which is simple and easy to operate.

In this embodiment, the fastening holes 203 there may be multiple fastening holes 203 and first adjustment holes 103, and the quantities of which are not specifically limited in the present application. As long as the slide plate 20 and the base plate can be relatively fixed by means of the fasteners 104 once the cutting distance between the slide plate 20 and the base plate is determined. Furthermore, the first adjustment hole 103 has a long strip structure to ensure that the base plate can slide to both sides relative to the slide plate 20 at a maximum distance. Furthermore, the number of the first adjustment holes 103 is two, extending in the first direction and arranged in parallel on both sides of the adjustment plate 10, and this ensures a stable connection between the base plate and the slide plate 20.

In this embodiment, the outer diameter of one end of the fastener 104 is larger than the width of the first adjustment hole 103. One end of the fastener 104 has a threaded structure, and the fastening hole 203 is a screw hole. In this embodiment, one end of the fastener 104 passes through the first adjustment hole 103 and is threadedly connected to the fastening hole 203, thereby tightly connecting the base plate and the slide plate 20.

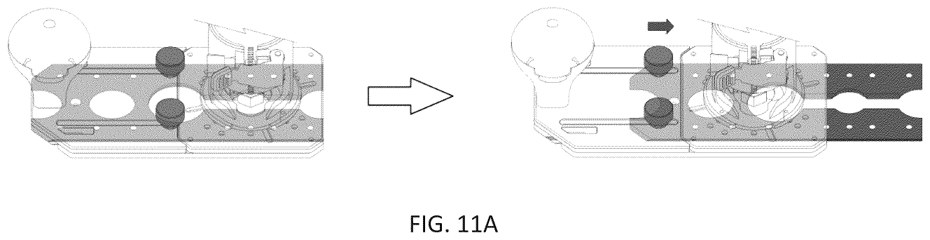

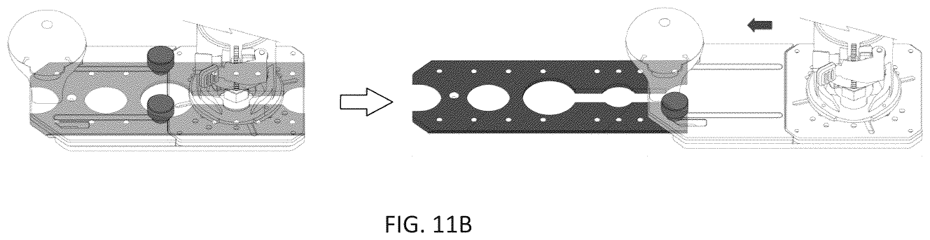

In this embodiment, the number of fastening holes 203 is multiple to further ensure that the base plate can slide to both sides relative to the slide plate 20 at a maximum distance. In this embodiment, take the number of fastening holes 203 as eight as an example. Referring to FIGS. 11a and 11b, where FIG. 11a shows that when the base plate slides leftwards relative to the slide plate 20 at a maximum distance, the fastener 104 is located on the rightmost side of the first adjustment hole 103 and connected to the leftmost connecting hole; FIG. 11b shows that when the base plate slides rightwards relative to the slide plate 20 at a maximum distance, the fastener 104 is located on the leftmost side of the first adjustment hole 103 and connected to the rightmost connecting hole.

Further, it further comprises a centering piece 14 that is detachably connected to the connecting plate 11 and a centering pin 13 adapted to the centering piece 14. The centering piece 14 is provided with a centering center coaxial with the first cut-opening 111. The centering pin 13 is adapted to the centering hole. Furthermore, the centering piece 14 and the centering pin 13 are used for assembly and correction of the trimming machine 90, thereby improving assembly accuracy and further improving operation accuracy.

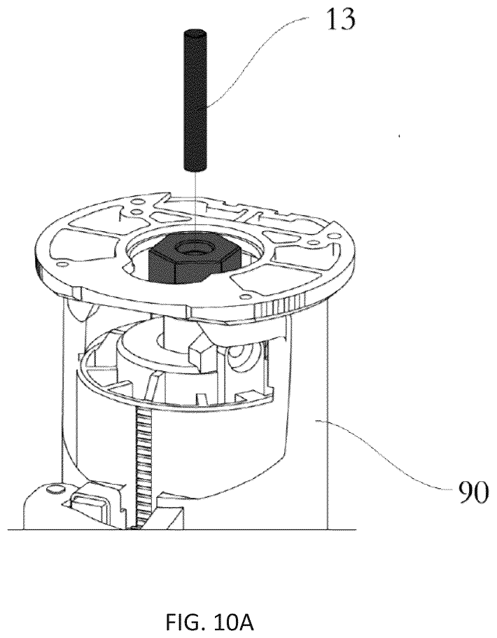

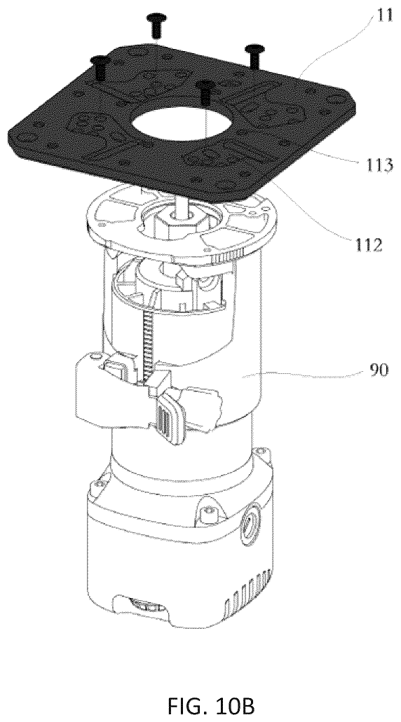

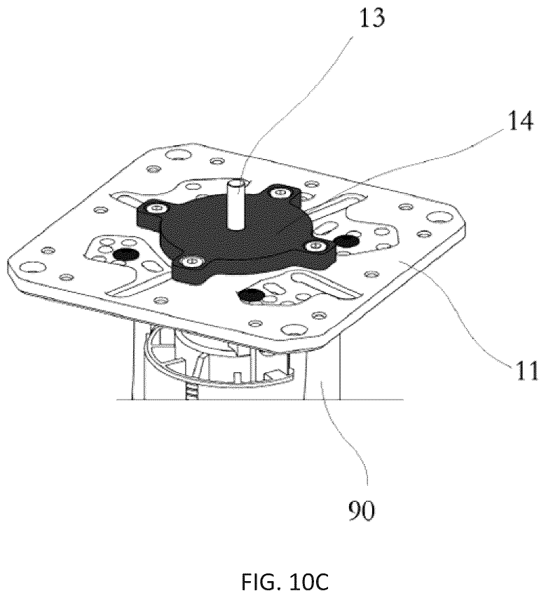

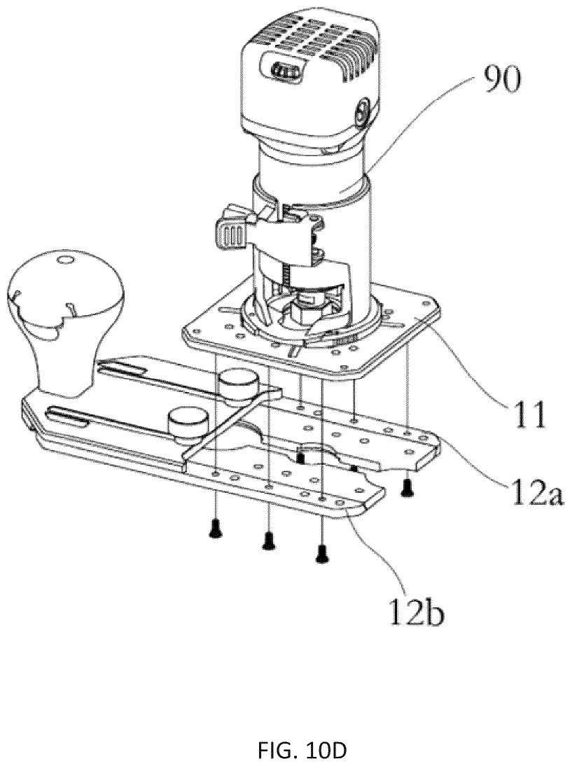

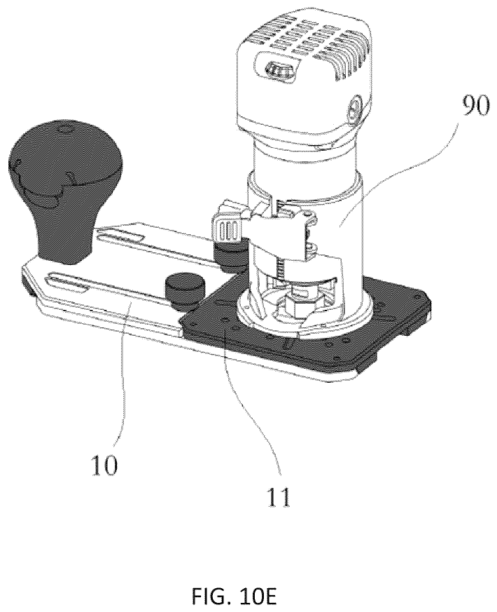

In actual cutting operations, in order to ensure the cutting accuracy of the trimming machine 90, the trimming machine 90 and the fixture need to be installed and calibrated during the installation process to prevent the trimming machine 90 or the cutter head of the trimming machine 90 from tilting, which affects the accuracy of cutting operation. FIGS. 10a-10e show the installation steps of the trimming machine 90:
S1. As shown in FIG. 10a, first remove the base of the trimming machine 90 from the trimming machine 90, and insert the centering pin 13 into the trimming machine 90;
S2. As shown in FIG. 10b, disassemble the connecting plate 11 and connect it with screws to the trimming machine 90. At this time, the screws do not need to be tightened; In this embodiment, the connecting plate 11 is provided with a connection area 112, and a plurality of first connecting holes are provided in the connection area 112 to adapt to different trimming machines 90.
S3. As shown in FIG. 10c, pass the centering pin 13 through the centering hole of the centering piece 14, and securely connect the centering pin 13 to the connecting plate 11; In this embodiment, the connecting plate 11 is provided with a plurality of second connecting holes 113 for connecting the centering piece 14.
S4. As shown in FIG. 10d, tighten the connecting plate 11 and the trimming machine 90 with screws to ensure that the connecting plate 11 and the trimming machine 90 are mounted in place, and remove the centering piece 14 and the centering pin 13;
S5. As shown in FIG. 10e, connect the connecting plate 11 to one side of the adjustment plate 10 to complete the assembly work.

Specifically, the base plate further comprises: a guide plate 12, the guide plate 12 being located at the bottom of the connecting plate 11 and the adjustment plate 10, and configured to detachably connect the adjustment plate 11 and the connecting plate 10; wherein a guide groove 121 is formed between the guide plate 12 and the connecting plate 11/the adjustment plate 10, and the slide plate 20 can be limitedly connected to the guide groove 121 and can linearly slide along the guide groove 121.

In this embodiment, the guide plate 12 has a strip structure, the guide plate 12 extends along the first direction, and there are two symmetrically arranged guide plates 12, namely the first guide plate 12a and the second guide plate 12b. The two guide plates 12 are detachably connected to both sides of the bottom of the adjustment plate 10 along the first direction, wherein the two guide plates 12 will extend from one end of the adjustment plate 10 to form an area for the connecting plate 11 to connect. In other words, the connecting plate 11 is embedded in the groove formed between the adjustment plate 10 and the two guide plates 12. Furthermore, the two ends of the guide plate 12 are fixedly connected to the connecting plate 11 and the bottom of the adjusting plate 10 by means of screws, and the screws are embedded in the guide plate 12 to avoid interference during cutting.

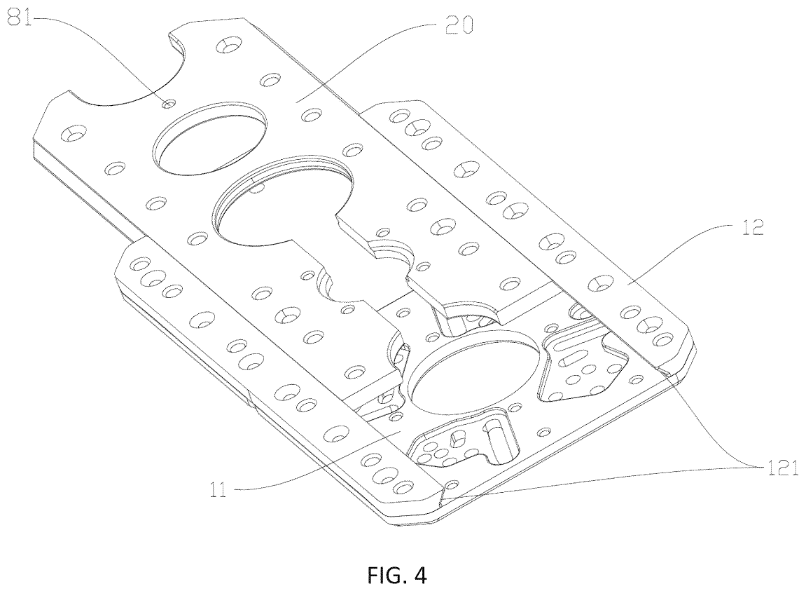

Specifically, as shown in FIG. 4, the guide groove 121 extends along the first direction, and the slide plate 20 is embedded in the corresponding guide groove 121 on both sides along the first direction, thereby achieving stable sliding between the slide plate 20 and the base plate. In this embodiment, the guide plate 12 is provided with a guide bevel on one side proximal to the bottom surface of the connecting plate 11 and the adjusting plate 10. A V-shaped guide groove 121 is formed between the guide bevel and the bottom surface of the connecting plate 11 and the adjusting plate 10. The two side edges of the slide plate 20 are V-shaped position-limiting bevels 202 adapted to the guide bevels so that the two side edges of the slide plate 20 are adapted to the guide grooves 121. Of course, in other embodiments, the guide grooves 121 are not limited to being V-shaped, and it can also be in other groove shapes, and the shapes of the edges on both sides of the slide plate 20 only need to match the guide groove 121.

It should be noted that the trimming machine 90 is connected to the guide plate 12 through the connecting plate 11, which can improve the connection stability between the trimming machine 90 and the base plate.

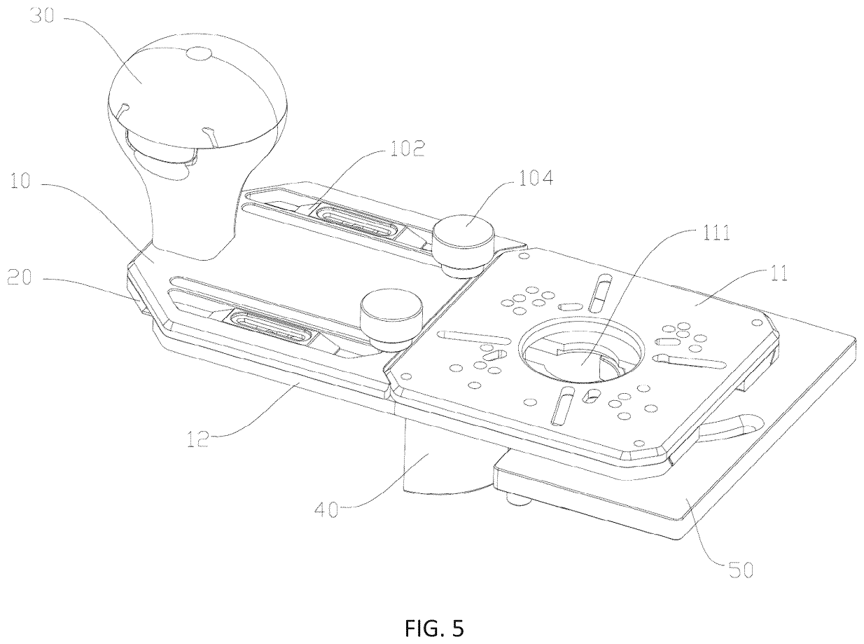

Specifically, as shown in FIGS. 5-7, the multifunctional trimming machine 90 has a grip handle 30 which is connected to one end of the base plate distal to the first cut-opening 111. The grip handle 30 is configured to be hand-held.

In this embodiment, the top of the grip handle 30 is spherical to facilitate holding, and the grip handle 30 smoothly transitions to the upper side of the base plate, further improving the user's grip comfort; wherein the bottom of the grip handle 30 can be fixed to the base plate with screws.

Further, the grip handle 30 is provided with a storage space. In this embodiment, the grip handle 30 comprises a connecting portion 301 and a hand-held portion 302. A storage space is provided on the connecting portion 301 to store auxiliary parts, wherein the hand-held portion 302 is semi-spherical and rotationally connected to the connecting portion 301 through a rotating shaft. The hand-held portion 302 is connected to the connecting portion 301 by snapping, so as to facilitate the user to open and close the storage space. In a further embodiment, the storage space can have multiple storage slots 303 according to the different shapes to facilitate positioning of auxiliary parts. In this embodiment, the auxiliary parts include but are not limited to screws, positioning pieces, centering pins, fasteners, hexagonal wrenches, bushings, etc.

Specifically, as shown in FIGS. 5-7, a shielding member 40 is detachably connected to the bottom of the slide plate 20 at a position corresponding to the second cut-opening 201. The shielding member 40 is configured to prevent cutting debris from splashing outwards. Furthermore, the slide plate 20 is provided with a first mounting hole 201b that is adapted to one end of the shielding member 40. One end of the shielding member 40 is mounted in the first mounting hole 201b and can rotate along the inside of the first mounting hole 201b. In this embodiment, the second cut-opening 201 is connected with the first mounting hole 201b or is arranged in the same hole.

In this embodiment, the shielding member 40 comprises a shielding portion 401, a mounting portion 402 and a clamping part 403 that are fixedly connected in sequence, wherein the shielding portion 401 is in the shape of a fan-shaped column. Specifically, the fan angle of the shielding portion 401 is less than 180 degrees. The shielding portion is configured to prevent cutting debris from splashing outwards. In this embodiment, the mounting portions 402 are arc-shaped strips, and there are at least two. The multiple mounting portions 402 correspond end to end to form an annular structure with multiple gaps. In this embodiment, there are two mounting portions 402, and they are arranged symmetrically, namely the first mounting portion 402a and the second mounting portion 402b. The first mounting portion 402a and the second mounting portion 402b are fixed to the top of the shielding portion 401 in an enclosed circle, wherein the first mounting portion 402a and the second mounting portion 402b have deformation gaps at both ends respectively. In this embodiment, the snapping portion 403 is in the shape of a strip arc, and the number of the snapping portions 403 corresponds to that of the mounting portions 402. In this embodiment, there are two snapping portions 403 symmetrically disposed to respectively correspond to the first mounting portion 402a and the second mounting portion 402b. Specifically, the snapping portion 403 is fixed on the outer peripheral side of the mounting portion 402. In other embodiments, the number of the mounting portions 402 and the snapping portions 403 is not limited to two.

In this embodiment, an arc-shaped groove is provided inside the first mounting hole 201b along the circumferential direction for at least two snapping portions 403 to be inserted. During the actual mounting operation, the two mounting portions 402 are squeezed. Due to the presence of the deformation gap, the two snapping portions 403 and the mounting portions 402 can smoothly enter the first mounting hole 201b. After the two mounting portions 402 are pressed by the contact, the snapping portion 403 is embedded into the arc-shaped groove under the reset effect of the mounting portions 402 to realize fixed connection between the shielding member 40 and the base plate. When it needs to be disassembled, downward pressure is applied to the shielding portion 40 to deform the two mounting portions 402, so that the snapping portion 403 can be disconnected from the arc-shaped groove, and the shielding member 40 is pulled out. Furthermore, since the snapping portion 403 and the mounting portion 402 are elastically snapped and embedded in the arc-shaped groove, in this embodiment, the snapping portion 403 and the mounting portion 402 can rotate in the circumferential direction along the arc-shaped groove, so as to facilitate the shielding portion 401 to face different directions, so that the cutter head of the trimming machine can be adapted to the shielding portion 401 in any second cut-opening.

During the cutting process of the trimming machine 90, cutting debris flies towards the shielding portion 401 and is blocked by the shielding portion 401, preventing it from splashing outwards, thereby improving the safety performance of the multifunctional trimming machine fixture of the present application. In addition, the shielding member 40 can be used with a chip suction device to ensure a clean working environment.

Specifically, the slide plate 20 is marked with a scale along the first direction.

In this embodiment, the scale can be fixed on the slide plate 20 by pasting or engraving. In some other embodiments, the scale can also be designed in the form of a groove, a protrusion, or printing, which is not specifically limited in this application. There are two rows of scales, which are respectively arranged on both sides of the slide plate 20.

Further, the base plate is provided with a cut-out hole 101 for viewing the scale.

In this embodiment, in order to facilitate viewing of the scale value, a cut-out hole 101 is provided on the base plate in the present application. In a further embodiment, the length of the slide plate 20 is the same as that of the base plate. When the slide plate 20 and the base plate are completely overlapped, the position corresponding to the cut-out hole 101 is 0 on the scale.

Specifically, the cut-out hole 101 has a long strip structure, and an indicator piece 102 that can move along the length direction of the cut-out hole 101 is provided in the cut-out hole 101. The indicator piece 102 is detachably connected to the base plate.

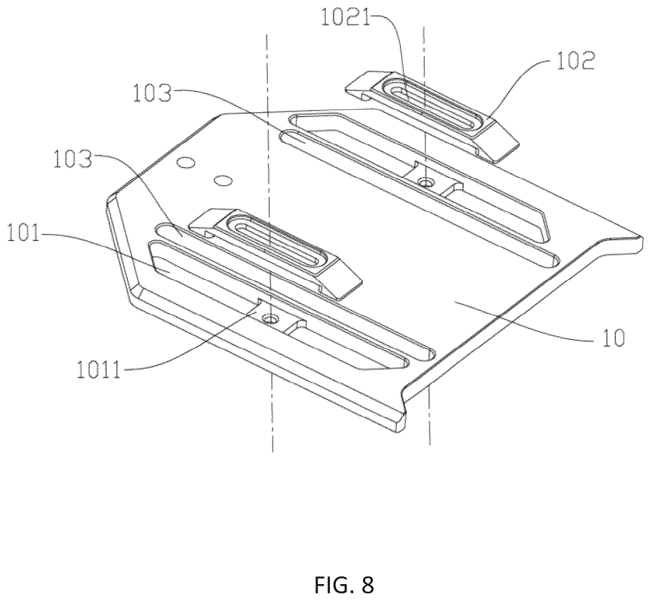

In this embodiment, as shown in FIG. 8, the indicator piece 102 is configured to indicate the scale position. The indicator piece 102 is in the shape of an equilateral trapezoid. That is, in this embodiment, both end surfaces of the indicator piece 102 are inclined planes to improve the accuracy of readings; wherein, the upper side of the indicating piece 102 is provided with a second adjustment hole 1021 along its length direction, and a mounting piece 1011 for supporting the indicating piece 102 is fixed inside the cut-out hole 101, and once the indicating piece 102 is placed at the corresponding position on the upper side of the mounting piece 1011, it can be fixed on the mounting plate 1011 by means of screws, which is simple and easy to operate. In a further embodiment, the length of the slide plate 20 is the same as that of the base plate. When the slide plate 20 and the base plate are completely overlapped, the position indicated by the indicator 102 is 0 on the scale.

In a further embodiment, the diameters of different cutter heads of the trimming machine 90 are different. In order to further improve the accuracy of readings, the second adjustment hole 1021 in this embodiment also has a long strip structure, and by fixing the indicator piece 102 at different positions in the second adjustment hole 1021 by means of screws, the indicator piece 102 can be fine-tuned to different positions according to the diameter of the cutter head, thereby overcoming the influence of cutter heads of different diameters on cutting accuracy.

For example, if the required cutting length or cutting radius is 100 mm, the base plate and the slide plate are slid relative to each other to adjust the corresponding length. Since the radius of the cutter head will affect the cutting length or cutting radius during cutting, the actual cutting length or cutting radius will become smaller, the radius of the cutter head needs to be added to the actual cutting length or cutting radius 100 mm. Different cutter heads have different diameters. For example, if the cutter head is 8 mm, that is, the cutting length or cutting radius needs to be adjusted to 104 mm. At this time, the base plate needs to be slid relative to the slide plate to further adjust the length of the distance by 4 mm. In this embodiment, by retracting the indicator piece 102 by 4 mm, the cutting distance or cutting radius can be recorded more directly and conveniently. The indicator piece 102 can be adjusted according to the cutter heads of different diameters to overcome the influence of cutter head radius.

Specifically, the fixture further comprises a center positioning member 80. The slide plate 20 is provided with a center positioning hole adapted to the center positioning member 80 along the length direction. The slide plate 20 can rotate with the central positioning member 80 as the center of a circle.

As shown in FIGS. 2, 3 and 12, in this embodiment, the fixture comprises a center positioning member 80 with a circular structure. The slide plate 20 is provided with one or more center positioning holes adapted to the center positioning member 80 along the length direction. The center positioning hole adapted to the center positioning member 80 can be used to connect the slide plate 20 to the center positioning member 80, and by fixing the center positioning member 80, the trimming machine 90 can be guided with the center positioning member 80 as the center of a circle to guide the trimming machine 90 to make circular rotation, so that the trimming machine 90 can cut an arc-shaped or circular tongue-and-groove structure on the material to be cut, or cut a circular groove structure on the material to be cut, or cut to form a circular raised structure on the material to be cut.

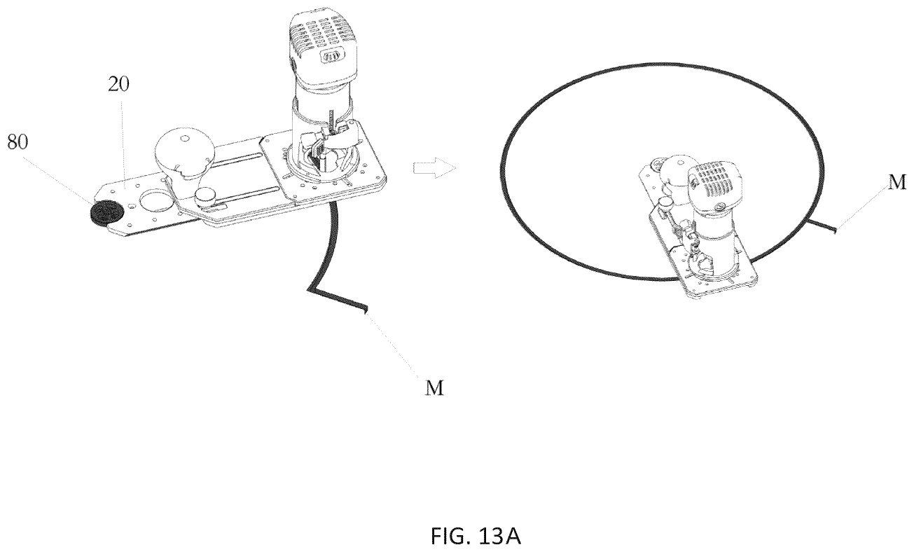

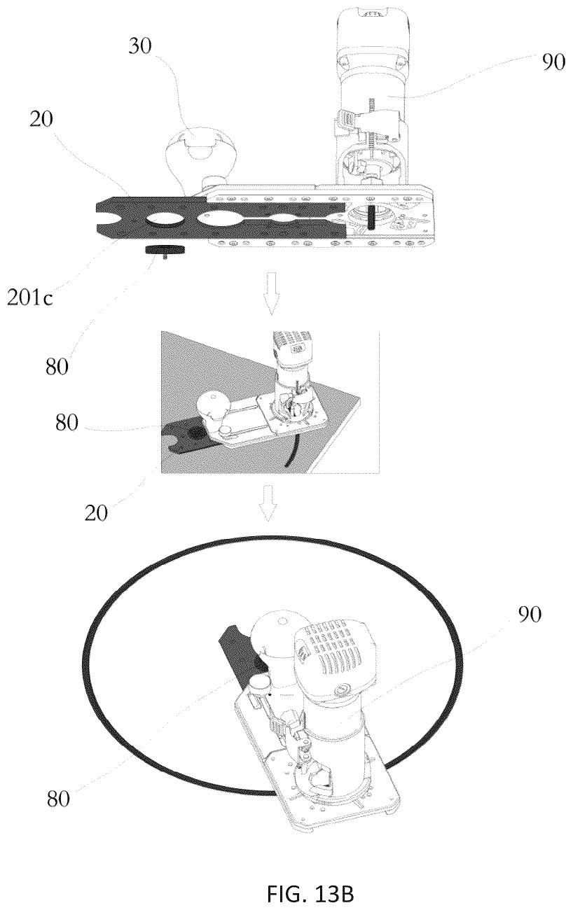

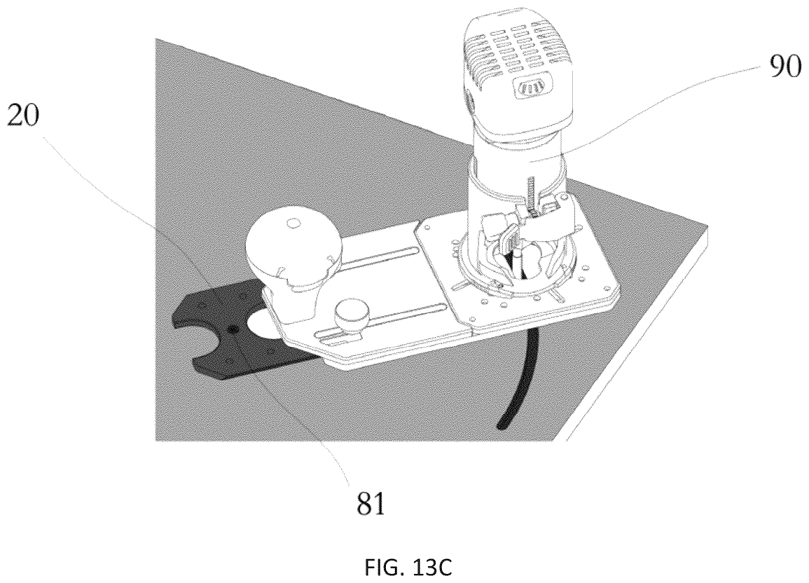

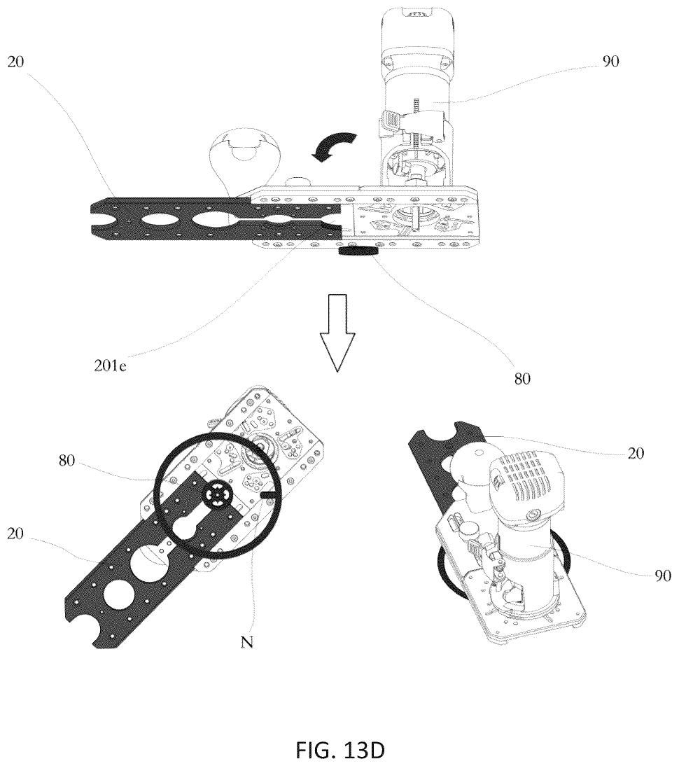

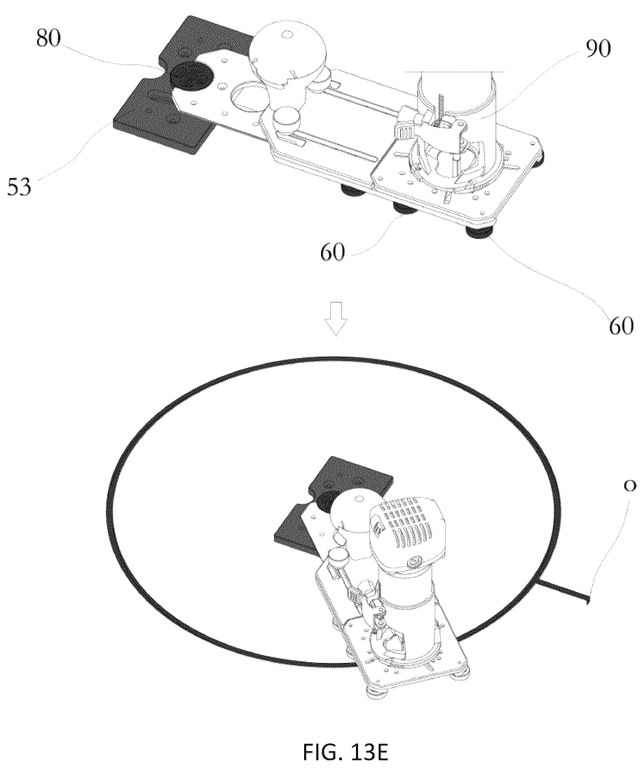

As shown further in FIGS. 2 and FIGS. 13a-13e, in this embodiment, the center positioning hole can be used to install the center positioning member 80 and can be connected with the second cutting opening 201. At the same time, the center positioning hole can also be used as the second cut-opening 201, for the cutter head of the trimming machine 90 to pass through for cutting. In this embodiment, the slide plate 20 is provided with multiple center positioning holes, and different center positioning holes can be used for different cutting methods. Furthermore, the number of center positioning holes in this embodiment is three, which are the first center positioning hole 201d, the second center positioning hole 201c, and the third center positioning hole 201e. The three center positioning holes are provided along the length direction of the slide plate 20, wherein the first center positioning hole 201d and the third center positioning hole 201e are respectively provided at both ends of the slide plate 20 and are arc-shaped hole structures opening toward the first direction.

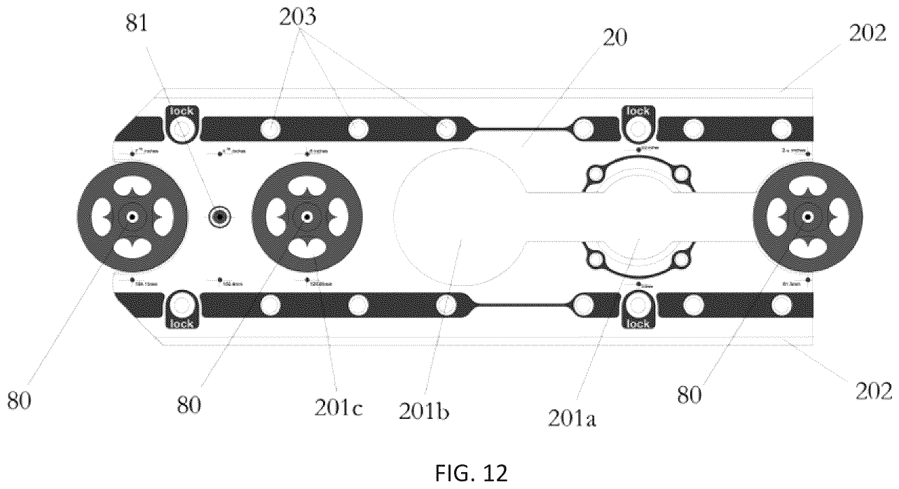

As shown in FIGS. 12 and 13a, a first cutting method is used to cut an arc-shaped or circular groove structure on the material to be cut, and the steps are as follows:
S1. Calculate the center position of the circular mortise on the material to be cut, and fix the center positioning member 80 at the center position; In this embodiment, screws can be used to fix the central positioning member 80, which is not limited here.
S2. According to the radius of the circular mortise, slide the slide plate 20 and the base plate relatively, and use the fasteners 104 to fix the slide plate 20 and the base plate; In this embodiment, the diameters of different cutter heads of the trimming machine 90 are different. In order to further improve the accuracy of readings, the second adjustment hole 1021 in this embodiment also has a long strip structure, and by fixing the indicator piece 102 at different positions in the second adjustment hole 1021 by means of screws, the indicator piece 102 can be fine-tuned to different positions according to the diameter of the cutter head to further determine zero on the scale, thereby overcoming the influence of cutter heads of different diameters on cutting accuracy.
S3. Start cutting with the cutter edge of the trimming machine 90 starting from the edge of the material to be cut, and gradually move the fixture by operating the grip handle 30 so that the first center positioning hole 201d gradually approaches and is engaged with the center positioning member 80; In this embodiment, the starting point of cutting is point M in FIG. 13a, and since the first center positioning hole 201d is located at the end of the slide plate and has an arc-shaped hole structure opening toward the first direction, it is convenient to operate the grip handle 30 to move the fixture to find the first center positioning hole 201d.
S4. With the center positioning member 80 as the center of a circle and the distance from the cutter head of the trimming machine 90 to the center positioning member 80 as the radius, perform circular mortise cutting operations; Using the first cutting method can ensure that the cutting forms a clean circular mortise structure. At the same time, because the cutter head cuts along the edge of the wood being cut as the starting point, damage to the cutter head can be avoided and the safety of the cutting operation is improved. The cutting method leaves the cutting path of the cutter head on the outside of the circular mortise, but results in a perfect inner circle.

As shown in FIGS. 12 and 13b, the second cutting method is used to cut an arc-shaped or circular groove structure on the material to be cut. The cutting steps are as follows:
S1. Calculate the center position of the circular mortise on the material to be cut, and fix the center positioning member 80 at the center position;
S2. According to the radius of the circular mortise, slide the slide plate 20 and the base plate relatively, and use the fasteners 104 to fix the slide plate 20 and the base plate;
S3. Correspond the position of the second center positioning hole 201c to that of the center positioning member 80, and correspond the position of the trimming machine 90 cutter head to the position to be cut, and raise one side of the trimming machine 90 to prevent the trimming machine 90 cutter head from having premature contact with the tabletop which will damage the cutter head or affect the safety of cutting operations;
S4. Start the trimming machine 90, and slowly lower the trimming machine 90. Match the second center positioning hole 201c with the center positioning member 80. The cutter head of the trimming machine 90 corresponds to the position to be cut, and with the center positioning member 80 taken as the center of a circle, and the distance from the cutter head of the trimming machine 90 to the center positioning member 80 taken as the radius, circular mortise cutting operation is performed; Using the second cutting method can ensure that a clean circular mortise structure is formed. There will be no cutting path left on the inner circle and the outer surface, and a perfect circular mortise structure can be formed. However, the stability in step S4 needs to be maintained during the operation process, in order to avoid damage to the cutter head and improve the safety of cutting operations.

As shown in FIGS. 12 and 13c, the principle of this cutting method is similar to the second cutting method. In this embodiment, the slide plate 20 is provided with auxiliary positioning holes 81 for fixing screws.

The third cutting method is used to cut an arc-shaped or circular groove structure on the material to be cut. The cutting steps are as follows:
S1. Calculate the center position of the circular mortise on the material to be cut, and open a position limiting hole matching the screw at the circular position;
S2. According to the radius of the circular mortise, slide the slide plate 20 and the base plate relatively, and use the fasteners 104 to fix the slide plate 20 and the base plate;
S3. Pre-install the screws in the auxiliary positioning holes 81 corresponding to the position of the position limiting holes. Correspond the position of the trimming machine 90 to the cutting position, and raise one side of the trimming machine 90 to prevent the trimming machine 90 cutter head from having premature contact with the tabletop which will damage the cutter head or affect the safety of cutting operations;
S4. Start the trimming machine 90, and slowly lower the trimming machine 90. Pass the screw through the auxiliary positioning hole 81 and match it with the position limiting hole. The cutter head of the trimming machine 90 corresponds to the position to be cut, and with the center positioning member 80 taken as the center of a circle, and the distance from the cutter head of the trimming machine 90 to the center positioning member 80 taken the radius, circular mortise cutting operation is performed;

Using the third cutting method can ensure that a clean circular mortise structure is formed. There will be no cutting path left on the inner circle and the outer surface, and a perfect circular mortise structure can be formed. However, the stability in step S4 needs to be maintained during the operation process, in order to avoid damage to the cutter head and improve the safety of cutting operations.

As shown in FIGS. 12 and 13d, the principle of this cutting method is similar to the first cutting method. The fourth cutting method is used to cut an arc-shaped or circular groove structure on the material to be cut. The cutting steps are as follows:
S1. Calculate the center position of the circular mortise on the material to be cut, and fix the center positioning member 80 at the center position; In this embodiment, screws can be used to fix the center positioning member 80, which is not limited here.
S2. According to the radius of the circular mortise, slide the slide plate 20 and the base plate relatively, and use the fasteners 104 to fix the slide plate 20 and the base plate; In this embodiment, the diameters of different cutter heads of the trimming machine 90 are different. In order to further improve the accuracy of readings, the second adjustment hole 1021 in this embodiment also has a long strip structure, and by fixing the indicator piece 102 at different positions in the second adjustment hole 1021 by means of screws, the indicator piece 102 can be fine-tuned to different positions according to the diameter of the cutter head to further determine zero on the scale, thereby overcoming the influence of cutter heads of different diameters on cutting accuracy.
S3. Start the trimming machine 90 and slowly contact the cutter head of the trimming machine 90 with the surface of the material to be cut. The cutting starting point is located inside the circular mortise to be cut; In this embodiment, the cutting starting point is point N in FIG. 13d.
S4. Operate the grip handle 30 to gradually move the fixture, so that the third center positioning hole 201e gradually approaches and is engaged with the center positioning member 80; In this embodiment, since the third center positioning hole 201e is located at the end of the slide plate and has an arc-shaped hole structure opening toward the first direction, it is convenient to operate the grip handle 30 to move the fixture to find the third center positioning hole 201e.
S5. With the center positioning member 80 taken as the center of a circle and the distance from the cutter head of the trimming machine 90 to the center positioning member 80 taken as the radius, circular mortise cutting operations are performed; Using the fourth cutting method can ensure that a clean circular mortise structure is formed. At the same time, since the cutting starting point is located inside the circular mortise to be cut, this cutting method will leave a cutter tip on the inside of the circular mortise, but can form a perfect outer circle.

In a further embodiment, the fixture further comprises a horizontal knob 60. The horizontal knob 60 can be detachably connected to the bottom of the base plate or to the bottom of the slide plate 20 through a threaded or screw connection. The horizontal knob 60 can be used to adjust the height of the base plate and the slide plate 20, so as to adapt to the materials being cut with different thicknesses.

In a further embodiment, the fixture further comprises a raising plate, which can be detachably connected to the bottom of the base plate through threaded or screwed connections or detachably connected to the bottom of the slide plate 20. The raising plate can be used to adjust the height of the base plate and the slide plate 20.

As shown in FIGS. 12 and 13e, the fifth cutting method is used to cut an arc-shaped or circular groove structure on the material to be cut. The steps are as follows:
S1. Calculate the center position of the circular mortise on the material to be cut, use a raising plate to bond it to the center of the circle, and fasten the center positioning member 80 to the raising plate and position it at the center of the circle; In this embodiment, double-sided tape can be used to fix the raising plate, and screws can be used to fix the center positioning member 80, which are not limited here.
S2. Connect the horizontal knob 60 to the bottom of the base plate so that when the first center positioning hole 201d matches with the center positioning member 80, the fixture maintains a horizontal position;
S3. According to the radius of the circular mortise, slide the slide plate 20 and the base plate relatively, and use the fasteners 104 to fix the slide plate 20 and the base plate;
S4. Start cutting with the cutting edge of the trimming machine 90 starting from the edge of the material to be cut, and gradually move the fixture by operating the grip handle 30 so that the first center positioning hole 201d gradually approaches and is engaged with the center positioning member 80; In this embodiment, the cutting starting point is point O in FIG. 13e.
S5. With the center positioning member 80 as the center of the circle and the distance from the cutter head of the trimming machine 90 to the center positioning member 80 as the radius, circular mortise cutting operations are performed; The fifth cutting method can ensure that the cutting forms a clean circular mortise structure. At the same time, because the cutter head cuts along the edge of the wood being cut as the starting point, damage to the cutter head can be avoided and the safety of the cutting operation is improved. The cutting method will leave a cutting path of the cutter head on the outside of the circular mortise. Compared with the first cutting method, this method will not leave any hole marks on the inner circle, thus forming a more perfect inner circle. Of course, the present invention is not limited to this method of circular mortise.

Further, the fixture also comprises an edge guide plate 50. The edge guide plate 50 is detachably connected to the bottom of the base plate or detachably connected to the bottom of the slide plate 20. The edge guide plate 50 can be used to guide the cutter head of the trimming machine 90 to cut along a preset trajectory or used to adjust the height of the base plate and the slide plate 20.

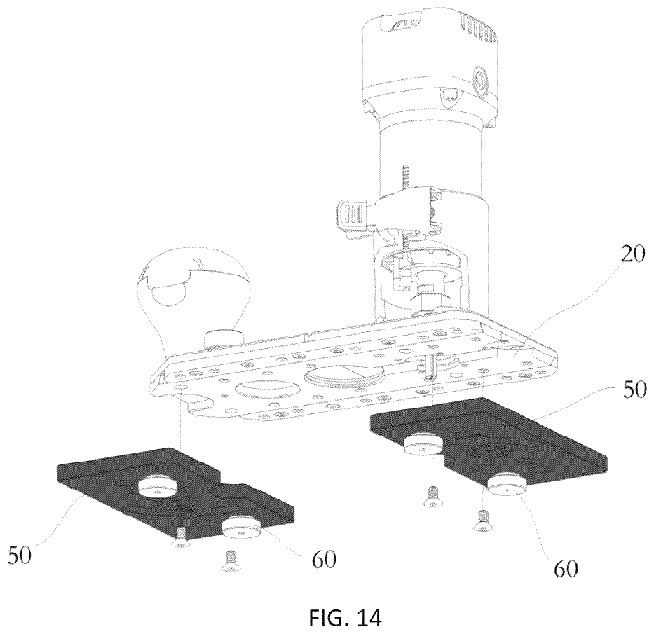

As shown in FIGS. 14-17, the edge guide plate 50 is detachably connected to the bottom of the base plate or slide plate 20 to guide the cutter head of the trimming machine 90 to cut along a preset trajectory.

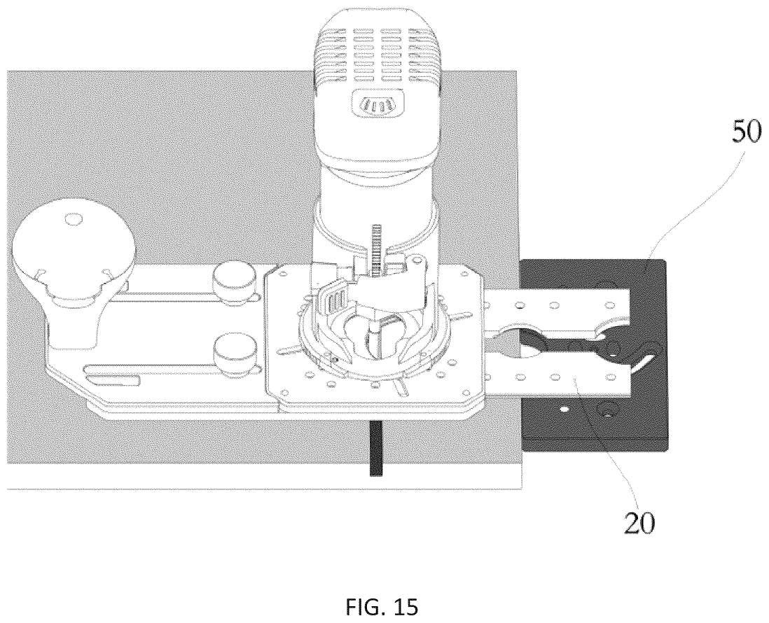

As shown in FIG. 14, the bottom of the slide plate 20 is provided with at least two rows of screw holes for installing the edge guide plate 50 along the first direction. The edge guide plate 50 can be detachably mounted on the bottom of the slide plate 20 by means of screws. When the edge guide plate 50 is mounted on the bottom of the slide plate 20 or the base plate and proximal to the side of the grip handle 30, the edge position of the trimming machine cutting the surface of the material to be cut can be more conveniently controlled. Further, as shown in FIG. 15, when the edge guide plate 50 is mounted on the bottom of the slide plate 20 or the base plate and distal to the side of the grip handle 30, the edge guide plate 50 is abutted against one side of the material to be cut, thereby guiding the cutter head to cut out tenon and groove, ensuring that the tenon and groove are flush with the edge, forming a perfect 90-degree angle. At the same time, this method is convenient for is convenient for measuring and marking with a ruler, and can be adjusted to any distance, which improves the accuracy of cutting and the diversity of applications. In a further embodiment, the horizontal knob 60 can be detachably connected to the bottom of the edge guide plate 50 through a thread or screw connection to adapt to materials of different thicknesses to be cut.

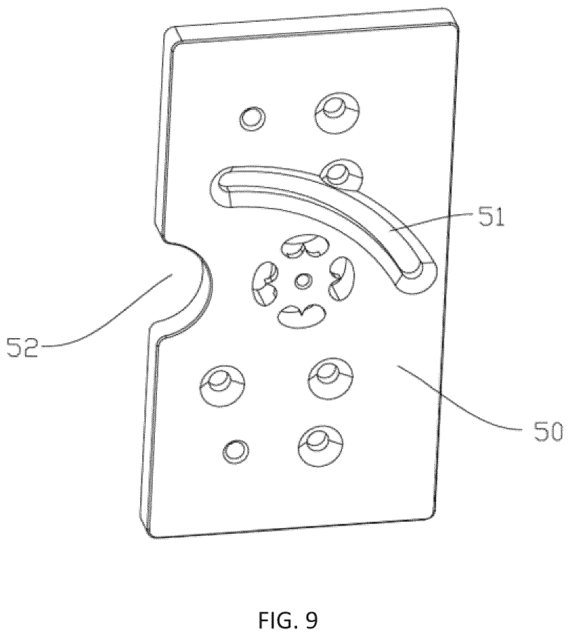

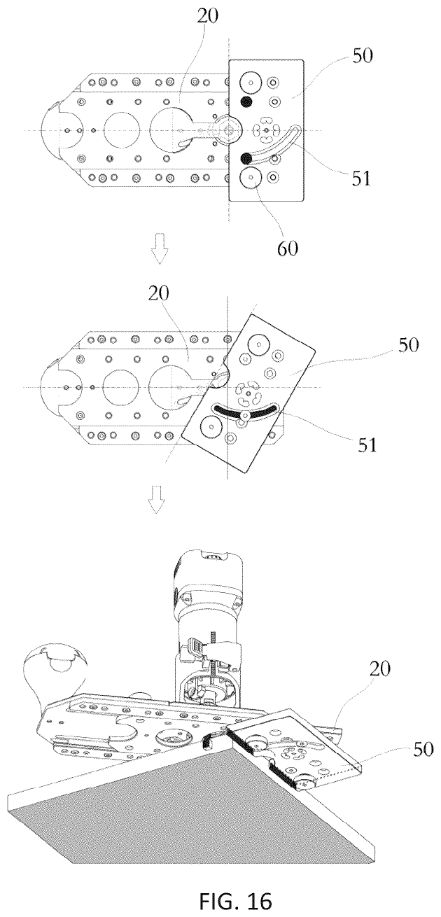

Specifically, the edge guide plate 50 is provided with an arc-shaped guide hole 51, and the guide hole 51 can be used to guide the edge guide plate 50 to be connected to the base plate or the bottom of the slide plate 20 at a preset angle. In this embodiment, as shown in FIG. 9, the edge guide plate 50 has a square structure, and an arc-shaped guide hole 51 is provided on the edge guide plate 50 along the width direction. Referring again to FIG. 16, the edge guide plate 50 is fixed to the bottom surface of the slide plate 20 by means of two screws, wherein one of the screws passes through the guide hole 51 and is screwed to the screw hole on the bottom surface of the slide plate 201, and the other screw passes through the center of the arc-shaped guide hole 51 and is connected to the screw hole on the bottom surface of the slide plate 20. The edge guide plate 50 can be centered at the center of the arc-shaped guide hole 51 and rotate along the arc-shaped guide hole 51 to adjust the angle between the edge guide plate 50 and the slide plate 20, which can be understood as adjusting the included angle between the length direction of the edge guide plate 50 and the first direction. The method can increase the contact area between the edge guide plate and the material being cut, and improve the stability of the trimming machine during operation. For example, as shown in FIG. 16, if the length direction of the edge guide plate 50 is kept perpendicular to the length direction of the slide plate, when the trimming machine cutter head cuts the starting point of the material, the length of the edge guide plate in contact with the edge of the material is only half the length of the edge guide plate 50, causing the cutter head to be unstable at the starting point of cutting and affecting cutting accuracy. In this embodiment, the edge guide plate 50 is rotated along the screw so that the length direction of the edge guide plate 50 and the length direction of the slide plate present a preset angle. When the cutter head of the trimming machine cuts the starting point of the material, the length of contact between the edge guide plate and the edge of the material exceeds half of the length of the edge guide plate 50 or is the edge length of the edge guide plate 50, thereby improving the stability of the trimming machine during operation and ensuring cutting accuracy. At the same time, the relative length of the base plate and the slide plate 20 can be adjusted according to the specific cutting distance and further used in combination with the edge guide plate 50. The cutting distance in this embodiment may refer to the distance from the mortise to the edge of the material to be cut. This method allows the fixture to have more contact with the surface of the material being cut before cutting begins, thereby ensuring control and stability during the operation and ensuring cutting accuracy.

In another specific embodiment, continuing to refer to FIG. 14, the bottom of the guide plate 12 is provided with at least two rows of screw holes for installing the edge guide plate 50 along the first direction, and the edge guide plate 50 can be detachably mounted to the bottom of the base plate by means of screws. This method fixes the edge guide plate 50 on the 0-degree plane and is connected to the bottom of the guide plate 12 instead of the slide plate 20, thereby further achieving stable and precise shearing.

As shown in FIG. 15, by abutting the edge guide plate 50 against one side of the material to be cut, the cutter head is guided to cut out the tenon and tenon groove, ensuring that the tenon and tenon groove are flush with the edge to form a perfect angle of 90 degrees. This method is convenient for measuring and marking with a ruler, and can be adjusted to any distance, which improves the accuracy of cutting and the diversity of applications.

Further referring to FIG. 9, the edge guide plate 50 has a square structure, and a dodging hole 52 corresponding to the second cut-opening 201 is provided on one side of the edge guide plate 50 to prevent the edge guide plate 50 from interfering with trimming during the cutting operation.

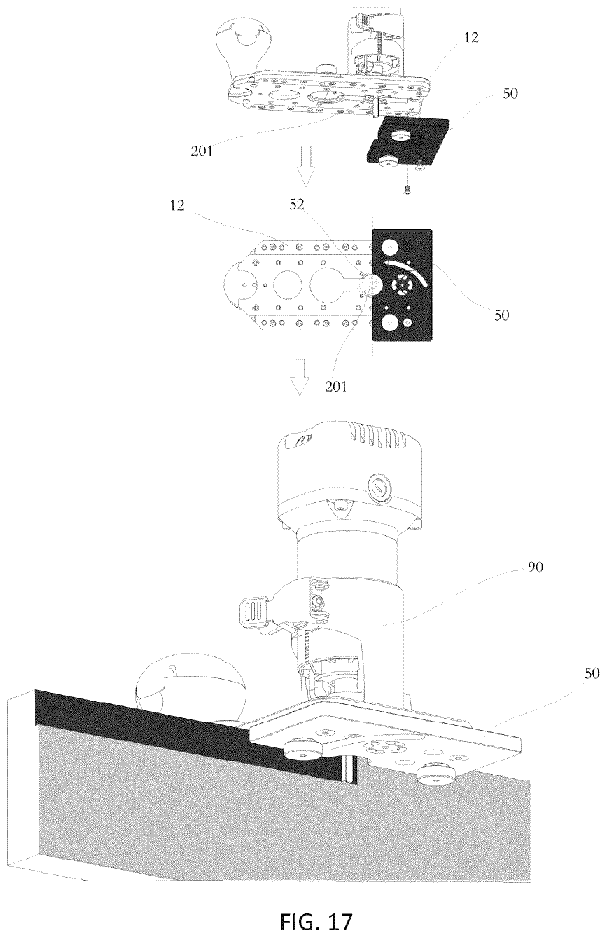

Referring further to FIG. 17, the edge guide plate 50 is perpendicularly fixed to the bottom surface of the edge guide plate 50 relative to the first direction by means of two screws. The edge on one side of the edge guide plate 50 proximal to the edge of the trimming machine 90 coincides with the cutting path, that is, the edge on one side of the edge guide plate 50 proximal to the cutter head of the trimming machine 90 is perpendicular to the axis of the cutter head of the trimming machine 90. Under the guidance of the edge guide plate 12, in this way, the cutter head can pass through the dodging hole 52 accurately and effectively to cut a clean and complete notch on the edge of the material to be cut.

In this embodiment, the edge guide plate 50 can be fixed to the bottom surface of the guide plate 12 or the bottom surface of the slide plate 20 respectively to achieve different cutting functions, so that the fixture can quickly switch the cutting function in a variety of application scenarios and improve work efficiency.

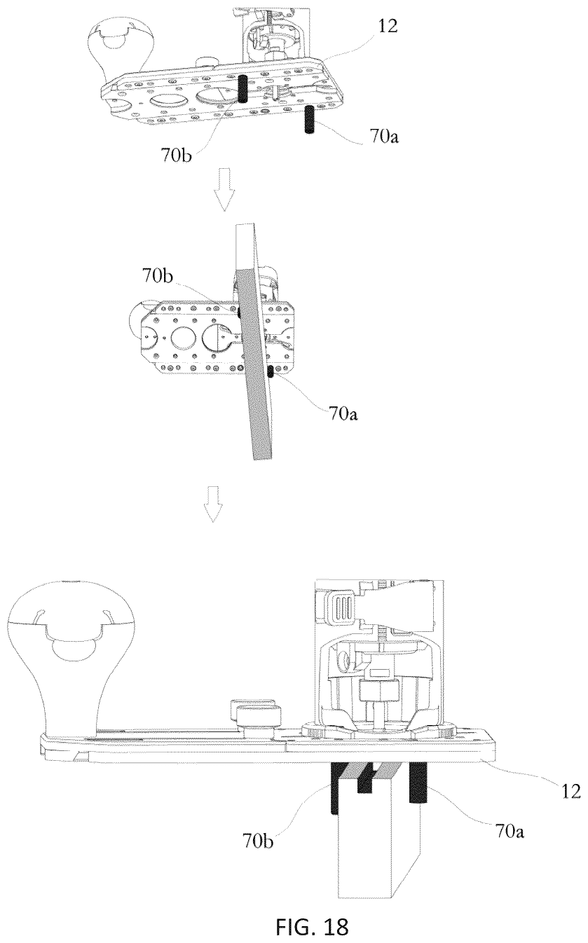

Specifically, as shown in FIG. 18, the fixture also includes a positioning pin 70 detachably connected to the bottom of the guide plate or the slide plate 20. The positioning pin 70 is used to limit the position of the object to be cut.

At least two positioning pins 70 are detachably connected to the bottom of the guide plate 12 or the slide plate 20 to guide the cutter head of the trimming machine 90 to cut along the preset trajectory.

Referring to FIG. 18, the bottoms of the slide plate 20 and the guide plate 12 are provided with at least two rows of screw holes for installing positioning pins 70 along the first direction. The edge guide plate 50 can be detachably mounted on the bottom of the slide plate 20 by means of screws. In this embodiment, the number of positioning pins 70 is two, namely a first positioning pin 70a and a second positioning pin 70b. For example, as shown in FIG. 18, the first positioning pin 70a is fixed to the bottom surface of the first guide plate 12a, and the second positioning pin 70b is fixed to the bottom surface of the second guide plate 12b. In this embodiment, the first positioning pin 70a and the second positioning pin 70b are staggered, and the material to be cut is limited between the first positioning pin 70a and the second positioning pin 70b. After fixing the material to be cut, the grip handle 30 is hand held and force is applied to make the first positioning pin 70a and the second positioning pin 70b tightly contact the outer wall of the material to be cut. This method can be performed from the beginning of cutting. It is carried out at the center of the material being cut to ensure the precision and accuracy of cutting and at the same time improve cutting efficiency.

Of course, in other embodiments, the number of positioning pins 70 can also be multiple, which is not limited here. A plurality of positioning pins 70 can be fixed on the bottom surface of the guide plate 12 according to the cutting requirements, or they can all be fixed on the bottom surface of the slide plate 20. Or they can be fixed on the bottom surface of the guide plate 12 and the bottom surface of the slide plate 20 at the same time, which is not limited here; the wood being cut can also be square or cylindrical, etc.

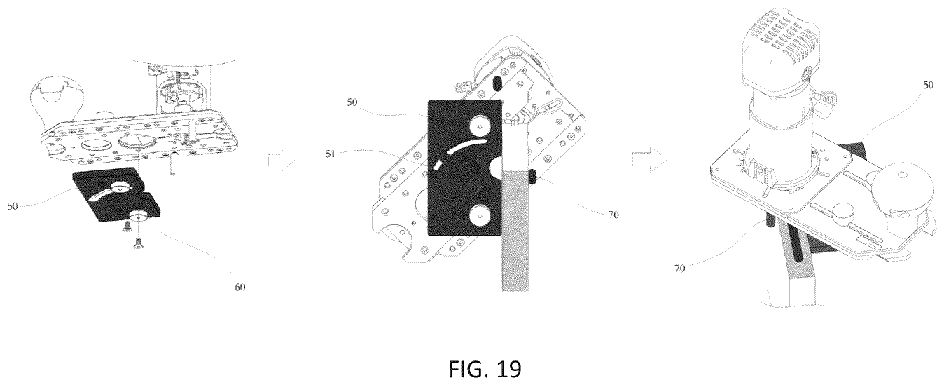

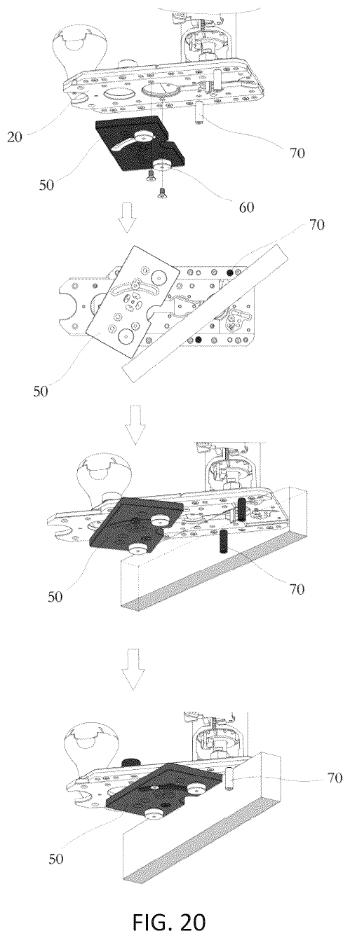

In further embodiments as shown in FIGS. 19 and 20, the edge guide plate 50 can have a larger contact area with the material to be cut than the positioning pin 70. In this embodiment, the edge guide plate 50 may be used in conjunction with at least one positioning pin 70 by connecting the edge guide plate 50 to the bottom surface of the guide plate 12 or the bottom of the slide plate 20 at the same time, to more stably limit the fixture on the material to be cut, ensuring stability during operation and improving operation accuracy. In this embodiment, the positions of the edge guide plate 50 and/or the positioning pins 70 can be selected and fixed on the guide plate or on the slide plate according to different materials to be cut. When the edge guide plate 50 and the positioning pins 70 are used together, the arc-shaped guiding hole on the edge guide plate 50 can easily guide the edge guide plate 50 to rotate at different angles, so as to increase the contact area between the edge guide plate 50 and the material being cut, thereby improving the stability of the cutting process. Of course, further, the edge guide plate 50 is also used together with the adjustment knobs, that is, at least two adjustment knobs are connected to the bottom of the edge guide plate 50 perpendicular to the first direction to increase the cutting height and improve cutting stability.

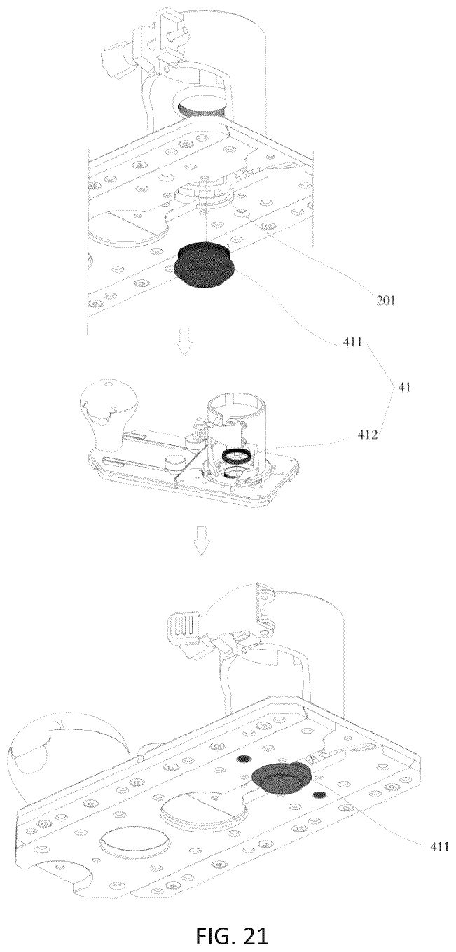

Specifically, as shown in FIGS. 21-23, the fixture also comprises a bushing 41 connected to the bottom of the slide plate 20. The bushing 41 can move along the edge of the object to be cut and can guide the cutter head of the trimming machine 90 to cut along the preset trajectory.

Further, as shown in FIG. 21, the slide plate 20 is provided with a second mounting hole 201a adapted to one end of the bushing 41. One end of the bushing 41 is fixedly mounted in the second mounting hole 201a, and the other end is extended from the bottom surface of the sliding plate 20. During the cutting process, the bushing 41 can contact the edge of the reference object and guide the cutter head of the trimming machine 90 to cut along the edge of the reference object, so that the cut mortise corresponds to the edge of the reference object.

Further, as shown in FIG. 21, the bushing 41 includes a hollow cylindrical body 411 with both ends open. The outer periphery of the body 411 is provided with an annular flange. The body 411 is divided into an upper portion and a lower portion by the annular flange. One side of the second mounting hole 201a proximal to the bottom surface of the slide plate 20 is provided with a mounting groove that matches the annular flange, and the annular flange is mounted in the mounting groove; the upper portion of the bushing 41 is extended from one end of the second mounting hole 201a proximal to the connecting plate 11 and is limitedly connected by means of the threaded ring 412. The lower portion of the bushing 41 is extended from one end of the second mounting hole 201a proximal to the bottom surface of the slide plate 20, and is abutted against the reference object. By providing the bushing 41, multifunctional cutting of the fixture is further realized.

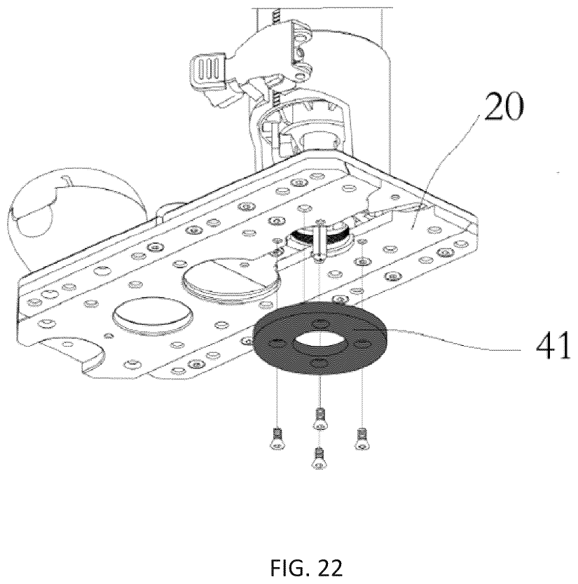

In a further embodiment as shown in FIG. 22, the bushing 41 can be customized according to specific needs. For example, the bushing 41 has an annular structure and is coaxially fixed to the bottom surface of the slide plate 20 with the second mounting hole 201a. During cutting operations, the outer wall of the bushing 41 is abutted against the reference object, thereby achieving precise cutting effects.

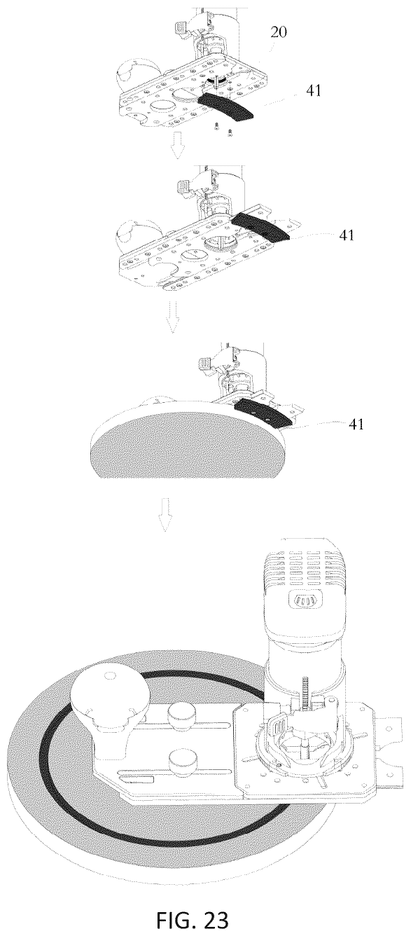

In a further embodiment as shown in FIG. 23, the bushing 41 can be further customized according to specific needs. For example, the bushing 41 has an arc-shaped or fan-shaped structure, which is fixed to the bottom surface of the slide plate 20. During cutting operations, the inner wall of the bushing 41 is abutted against the reference object, thereby achieving precise cutting effects.

The trimming machine fixture is reasonably and compactly structured, can be conveniently disassembled and assembled, safe to use, provides cutting stability and high cutting accuracy during use, and capable of enabling quick switch of cutting function in a variety of application scenarios, such as grinding, chamfering and grooving the edges of wood, cutting tenon grooves on thinner wood, cutting the wood into preset shapes (curved, circular, etc), thereby improving work efficiency.

One or more illustrative examples incorporating the examples disclosed herein are presented. Not all features of a physical implementation are described or shown in this application for the sake of clarity. Therefore, the disclosed systems and methods are well adapted to attain the ends and advantages mentioned, as well as those that are inherent therein. The particular examples disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown other than as described in the claims below. It is therefore evident that the particular illustrative examples disclosed above may be altered, combined, or modified, and all such variations are considered within the scope of the present disclosure. The systems and methods illustratively disclosed herein may suitably be practiced in the absence of any element that is not specifically disclosed herein and/or any optional element disclosed herein.

Although the present disclosure and its advantages have been described in detail, it should be understood that various changes, substitutions and alterations can be made herein without departing from the spirit and scope of the disclosure as defined by the following claims.

What is claimed is:

1. A multifunctional trimming machine fixture, comprising:
a base plate on which the trimming machine is detachably connected, the base plate is provided with a first cut-opening corresponding to the position of the trimming machine, and the cutter head of the trimming machine can pass through the first cut-opening to perform cutting;
a slide plate, the slide plate is slidably connected to the bottom of the base plate along a first direction and can be fastened to a preset position on the bottom of the base plate by means of fasteners; wherein the slide plate is provided with at least one second cut-opening corresponding to the first cut-opening along the first direction.

2. The multifunctional trimming machine fixture according to claim 1, characterized in that the base plate comprises:
a connecting plate configured to be connected to the trimming machine;
an adjustment plate connected to one side of the connecting plate; wherein the adjustment plate is provided with an adjustment hole, the slide plate is provided with a number of fastening holes corresponding to the adjustment hole along the first direction, and the fasteners can be adapted to connect with the fastening holes along the adjustment hole and can be used to fasten the slide plate.

3. The multifunctional trimming machine fixture according to claim 2, characterized in that the base plate further comprises:
a guide plate, the guide plate being located at the bottom of the connecting plate and the adjustment plate, and configured to detachably connect the adjustment plate and the connecting plate;
wherein a guide groove is formed between the guide plate and the connecting plate/the adjustment plate, and the slide plate can be limitedly connected to the guide groove and can linearly slide along the guide groove.

4. The multifunctional trimming machine fixture according to claim 1, further comprising:
a grip handle, the grip handle being connected to the base plate at one end thereof distal to the first cut-opening, wherein the grip handle is configured to be hand held.

5. The multifunctional trimming machine fixture according to claim 4, characterized in that a storage space is provided in the grip handle.

6. The multifunctional trimming machine fixture according to claim 1, characterized in that a shielding member is detachably connected to the bottom of the slide plate corresponding to the position of the second cut-opening, and the shielding member is configured to prevent cutting debris from splashing outwards.

7. The multifunctional trimming machine fixture according to claim 6, characterized in that the slide plate is provided with a first mounting hole adapted to one end of the shielding member, and one end of the shielding member is mounted in the first mounting hole and can rotate along the inside of the first mounting hole.

8. The multifunctional trimming machine fixture according to claim 7, characterized in that the shielding member comprises a shielding portion, mounting portions and a snapping portion that are fixedly connected in sequence; the mounting portions are in the shape of an arc strip, and there are at least two, and the snapping portion is fixedly provided on the outer peripheral side of the mounting portion; the circumferential inner wall of the first mounting hole is provided with an arc-shaped groove for the snapping portion to be extruded and inserted.

9. The multifunctional trimming machine fixture according to claim 1, characterized in that a scale is marked on the slide plate along the first direction.

10. The multifunctional trimming machine fixture according to claim 9, characterized in that the base plate is provided with a cut-out hole for viewing the scale.

11. The multifunctional trimming machine fixture according to claim 10, characterized in that the cut-out hole has a long strip structure, and an indicator piece that can move along the length direction of the cut-out hole is provided in the cut-out hole, the indicator piece is configured to indicate the scale, and the indicator piece is detachably connected to the base plate.

12. The multifunctional trimming machine fixture according to claim 1, characterized in that the second cut-opening is opened at one end of the slide plate along the first direction, and when the slide plate slides relative to the base plate, the cutter head of the trimming machine can move linearly along the second cut-opening and/or move out of the edge of the slide plate along one end of the second cut-opening.

13. The multifunctional trimming machine fixture according to claim 1, further comprising an edge guide plate, the edge guide plate being detachably connected to the bottom of the base plate or the bottom of the slide plate, the edge guide plate can be used to guide the cutter head of the trimming machine to cut along a preset trajectory or to adjust the height of the base plate and the slide plate.

14. The multifunctional trimming machine fixture according to claim 13, characterized in that the edge guide plate is provided with an arc-shaped guide hole, and the guide hole can be used to guide the edge guide plate to be connected to the bottom of the base plate or the slide plate at a preset angle.

15. The multifunctional trimming machine fixture according to claim 1, further comprising a center positioning member, and the slide plate is provided with at least one center positioning hole adapted to the center positioning member along the length direction, the slide plate can rotate with the central positioning member as the center of a circle.

16. The multifunctional trimming machine fixture according to claim 1, further comprising a bushing connected to the bottom of the slide plate, the bushing being movable along the edge of the object to be cut and capable of guiding the cutter head of the trimming machine to cut along a preset trajectory.

17. The multifunctional trimming machine fixture according to claim 1, further comprising a positioning pin detachably connected to the bottom of the guide plate or the slide plate, the positioning pin being configured to limit the object to be cut.

18. The multifunctional trimming machine fixture according to claim 1, further comprising a horizontal knob, the horizontal knob being detachably connected to the bottom of the base plate or the bottom of the slide plate, and the horizontal knob can be used to adjust the height of the base plate and the slide plate.

19. The multifunctional trimming machine fixture according to claim 1, further comprising a centering piece detachably connected to the connecting plate and a centering pin adapted to the centering piece, a centering hole coaxial with the first cut-opening is provided at the center of the centering piece, and the centering pin is adapted to the centering hole.
